(19) United States
(12) Patent Application Publication
(10) Pub. No.: US 2012/0091206 A1
(43) Pub. Date: Apr. 19, 2012

(54) METHOD AND APPARATUS FOR CAPTURING IMAGES WITH VARIABLE SIZES

(75) Inventor: David P. Goren, Smithtown, NY (US)

(73) Assignee: Symbol Technologies, Inc., Schaumburg, IL (US)

(21) Appl. No.: 12/905,194

(22) Filed: Oct. 15, 2010

(51) Int. Cl. G06K 7/14

(52) U.S. Cl. 235/470

(57) ABSTRACT

A method and apparatus for imaging targets with an imaging reader. The method includes: operatively connecting an application specific integrated circuit (ASIC) to the solid-state imager to receive the image data from the solid-state imager and generating a stream of combined data frames by the ASIC. A combined data frame in the stream generated by the ASIC including an image frame from the image data and a header. The method also includes receiving and processing the stream of combined data frames from the ASIC at a controller operatively connected to the ASIC.

### FIELD OF THE DISCLOSURE

The present disclosure relates generally to imaging-based barcode scanners

### BACKGROUND

Solid-state imaging systems or imaging readers have been used, in both handheld and hands-free modes of operation, to capture images from diverse targets, such as symbols to be electro-optically decoded and read and/or non-symbols to be processed for storage and display. Symbols include one-dimensional bar code symbols, particularly of the Universal Product Code (UPC) symbology, each having a linear row of bars and spaces spaced apart along a scan direction, as well as two-dimensional symbols, such as Code 49, a symbology that introduced the concept of vertically stacking a plurality of rows of bar and space patterns in a single symbol, as described in U.S. Pat. No. 4,794,239. Another two-dimensional code symbology for increasing the amount of data that can be represented or stored on a given amount of surface area is known as PDF417 and is described in U.S. Pat. No. 5,304,786. Non-symbol targets can include any person, place or thing, e.g., a signature, whose image is desired to be captured by the imaging reader.

The imaging reader includes a solid-state imager having an array of photocells or light sensors that correspond to image elements or pixels in a two-dimensional field of view of the imager, an illuminating light assembly for uniformly illuminating the target with illumination light having a settable intensity level over a settable illumination time period, and an imaging lens assembly for capturing return illumination and/or ambient light scattered and/or reflected from the target being imaged, and for adjustably focusing the return light at a settable focal length onto the sensor array to initiate capture of an image of the target as pixel data over a settable exposure time period.

The imager may be a one- or two-dimensional charge coupled device (CCD) or a complementary metal oxide semiconductor (CMOS) device and includes associated circuits for converting the pixel data into image data or electrical signals corresponding to a one- or two-dimensional array of the pixel data at a settable gain over the field of view. The imager is analogous to the imager used in an electronic camera. An aiming light assembly is also typically mounted in the imaging reader, especially in the handheld mode, to help an operator accurately aim the reader at the target with an aiming light having a settable intensity level over a settable aiming time period.

The imager captures the return light under the control of a controller or programmed microprocessor that is operative for setting the various settable system parameters with system data, and for processing the electrical signals from the imager. When the target is a symbol, the controller is operative for processing and decoding the electrical signals into decoded information indicative of the symbol being imaged and read. When the target is a non-symbol, the controller is operative for processing the electrical signals into a processed image of the target, including, among other things, de-skewing the captured image, re-sampling the captured image to be of a desired size, enhancing the quality of the captured image, compressing the captured image, and transmitting the processed image to a local memory or a remote host.

It is therefore known to use the imager for capturing a monochrome image of the symbol as, for example, disclosed in U.S. Pat. No. 5,703,349. It is also known to use the imager with multiple buried channels for capturing a full color image of the symbol as, for example, disclosed in U.S. Pat. No. 4,613,895. It is common to provide a two-dimensional CCD with a 640×480 resolution commonly found in VGA monitors, although other resolution sizes are possible.

The imager is operatively connected to the controller via an image data bus or channel over which the image data is transmitted from the imager to the controller, as well as a system bus or channel over which the system data is bi-directionally transmitted between the imager and the controller. Such system data includes, among other things, control settings by which the controller sets one or more of the settable exposure time period for the imager, the settable gain for the imager, the settable focal length for the imaging lens assembly, the settable illumination time period for the illumination light, the settable intensity level for the illumination light, the settable aiming time period for the aiming light, the settable intensity level for the aiming light, as well as myriad other system functions, such as decode restrictions, de-skewing parameters, re-sampling parameters, enhancing parameters, data compression parameters and how often and when to transmit the processed image away from the controller, and so on.

As advantageous as such known imaging readers have been in capturing images of symbols and non-symbols and in decoding symbols into identifying information, the separate delivery of the image data over the image data bus and the system data over the system data bus from the imager to the controller made it difficult for the controller to associate the system data with its corresponding image data. This imposed an extra burden on the controller, which was already burdened with controlling operation of all the components of the imaging reader, as well as processing the image data for the target. It would be desirable to reduce the burden imposed on the controllers of such imaging readers and to enhance the responsiveness and reading performance of such imaging readers. In addition, there is the need for dynamically acquiring images of different sizes with barcode imagers.

### SUMMARY

In one aspect, the invention is directed to a method of imaging targets with an imaging reader. The method includes: (1) capturing return light from a target over a field of view of a solid-state imager having an array of image sensors, and generating image data corresponding to the target; (2) operatively connecting an application specific integrated circuit (ASIC) to the solid-state imager to receive the image data from the solid-state imager; (3) generating a stream of combined data frames by the ASIC, a combined data frame in the stream generated by the ASIC including an image frame from the image data and a header; and (4) receiving and processing the stream of combined data frames from the ASIC at a controller operatively connected to the ASIC.

In another aspect, the invention is directed to a method of imaging targets with an imaging reader. The imaging reader including (1) a solid-state imager having an array of image sensors for capturing return light from a target over a field of view, and (2) an application specific integrated circuit (ASIC) operatively connected to the solid-state imager via an image data bus. The method includes (1) acquiring a first image frame having a first number of pixels by the solid-state imager, and combining the first image frame with a first header by the ASIC to form a first combined data frame; (2) acquiring a second image frame having a second number of pixels by the solid-state imager, and combining the second image frame with a second header by the ASIC to form a second combined data frame, wherein the first number of pixels for the first image frame is different from the second number of pixels for the second image frame; and (3) outputting from the ASIC to a controller a stream of combined data frames that includes the first combined data frame and the second combined data frame.

Implementations of the invention can include one or more of the following advantages. Variable image frames can be more easily captured and processed. Dynamically acquiring images of different sizes enables a barcode reader to capture sub-sections of the image. Capturing a sub-section of the image can increase the frame rate of the image capture, thereby increasing decode aggressiveness. These and other advantages of the present invention will become apparent to those skilled in the art upon a reading of the following specification of the invention and a study of the several figures of the drawings.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a perspective view of a portable imaging reader operative in either a handheld mode, or a hands-free mode, for capturing return light from targets;

FIG. 2 is a schematic diagram of various components of the reader of FIG. 1 in accordance with this invention;

FIG. 3 is a schematic diagram depicting a dual channel communication between the imager, the ASIC and the controller of the reader components of FIG. 2;

FIG. 4 is a series of signal timing waveforms depicting various signals, including a combined data signal, in the operation of the reader of FIG. 1; and

FIG. 5 is a flow chart depicting an aspect of the processing of the combined data signal of FIG. 4.

FIG. 6 is a block diagram that depicts an ASIC 50 configured to generate a stream of combined data frames wherein a combined data frame includes an image frame and a header in accordance with some embodiments.

FIG. 7 is a flowchart of a method for acquiring frames of variable sizes with a barcode imager in accordance with some embodiments.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

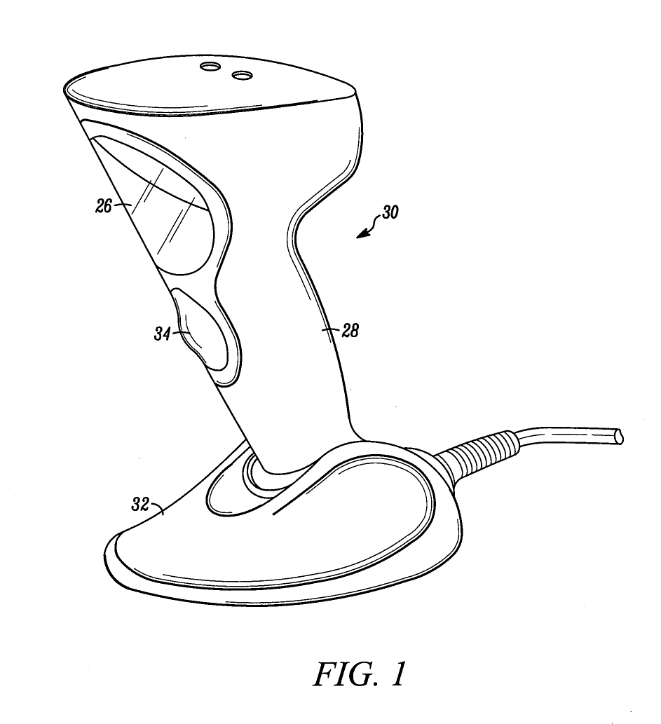

Reference numeral 30 in FIG. 1 generally identifies an imaging reader having a generally upright window 26 and a gun-shaped housing 28 supported by a base 32 for supporting the imaging reader 30 on a countertop. The imaging reader 30 can thus be used in a hands-free mode as a stationary workstation in which targets are slid, swiped past, or presented to, the window 26, or can be picked up off the countertop and held in an operator's hand and used in a handheld mode in which the reader is moved, and a trigger 34 is manually depressed to initiate imaging of targets, especially one- or two-dimensional symbols, and/or non-symbols, located at, or at a distance from, the window 26. In another variation, the base 32 can be omitted, and housings of other configurations can be employed. A cable, as illustrated in FIG. 1, connected to the base 32 can also be omitted, in which case, the reader 30 communicates with a remote host by a wireless link, and the reader is electrically powered by an on-board battery.

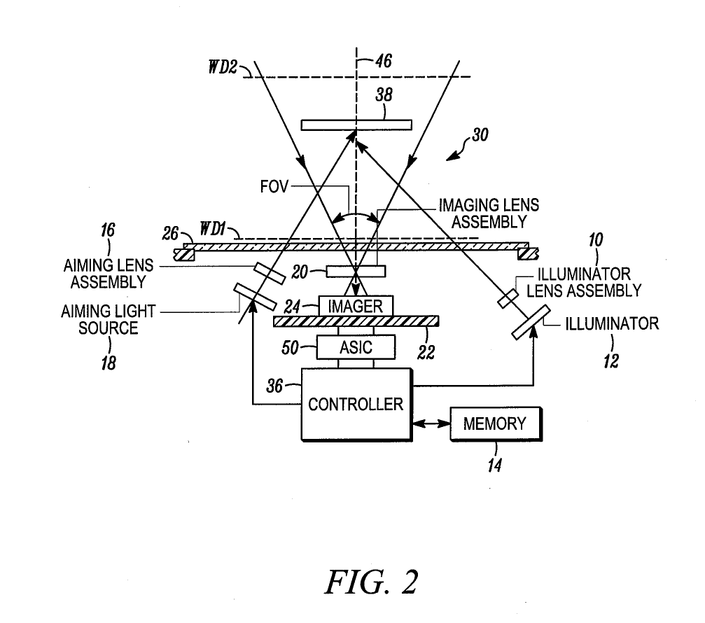

As schematically shown in FIG. 2, an imager 24 is mounted on a printed circuit board 22 in the reader. The imager 24 is a solid-state device, for example, a CCD or a CMOS imager having a one-dimensional array of addressable image sensors or pixels arranged in a single, linear row, or a two-dimensional array of such sensors arranged in mutually orthogonal rows and columns, and operative for detecting return light captured by an imaging lens assembly 20 along an optical path or axis 46 through the window 26. The return light is scattered and/or reflected from a target 38 as pixel data over a two-dimensional field of view. The imager 24 includes electrical circuitry having a settable gain for converting the pixel data to analog electrical signals, and a digitizer for digitizing the analog signals to digitized electrical signals or image data. The imaging lens assembly 20 is operative for adjustably focusing the return light at a settable focal length onto the array of image sensors to enable the target 38 to be read. The target 38 is located anywhere in a working range of distances between a close-in working distance (WD1) and a far-out working distance (WD2). In a preferred embodiment, WD1 is about four to six inches from the imager 24, and WD2 can be many feet from the window 26, for example, around fifty feet away.

An illuminating assembly is also mounted in the imaging reader and preferably includes an illuminator or illuminating light source 12, e.g., a light emitting diode (LED) or a laser, and an illuminating lens assembly 10 to uniformly illuminate the target 38 with an illuminating light having a settable intensity level over a settable illumination time period. The light source 12 is preferably pulsed.

An aiming assembly is also preferably mounted in the imaging reader and preferably includes an aiming light source 18, e.g., an LED or a laser, for emitting an aiming light with a settable intensity level over a settable illumination time period, and an aiming lens assembly 16 for generating a visible aiming light pattern from the aiming light on the target 38. The aiming pattern is useful to help the operator accurately aim the reader at the target 38.

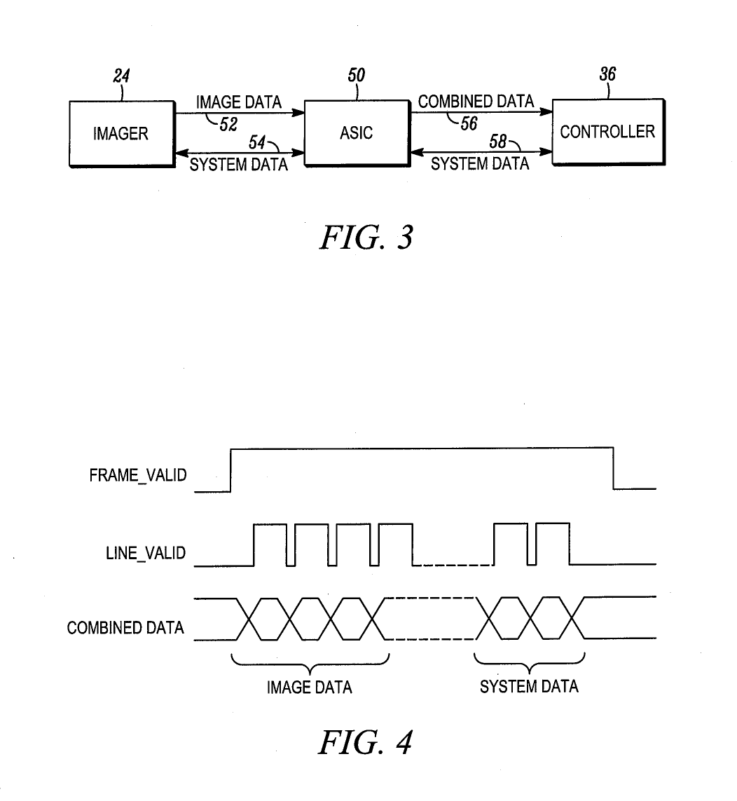

As shown in FIG. 2, the illuminating light source 12 and the aiming light source 18 are operatively connected to a controller or programmed microprocessor 36 operative for controlling the operation of these components. The imager 24, as best seen in FIG. 3, is operatively connected to the controller 36 via an application specific integrated circuit (ASIC) 50. The ASIC 50 and/or the controller 36 control the imager 24, the illuminating light source 12, and the aiming light source 18. A local memory 14 is accessible by the controller 36 for storing and retrieving data.

In operation, the controller 36 sends a command signal to energize the aiming light source 18 prior to image capture, and also pulses the illuminating light source 12 for the illumination time period, say 500 microseconds or less, and energizes and exposes the imager 24 to collect light, e.g., illumination light and/or ambient light, from the target during an exposure time period. A typical array needs about 16-33 milliseconds to acquire the entire target image and operates at a frame rate of about 30-60 frames per second.

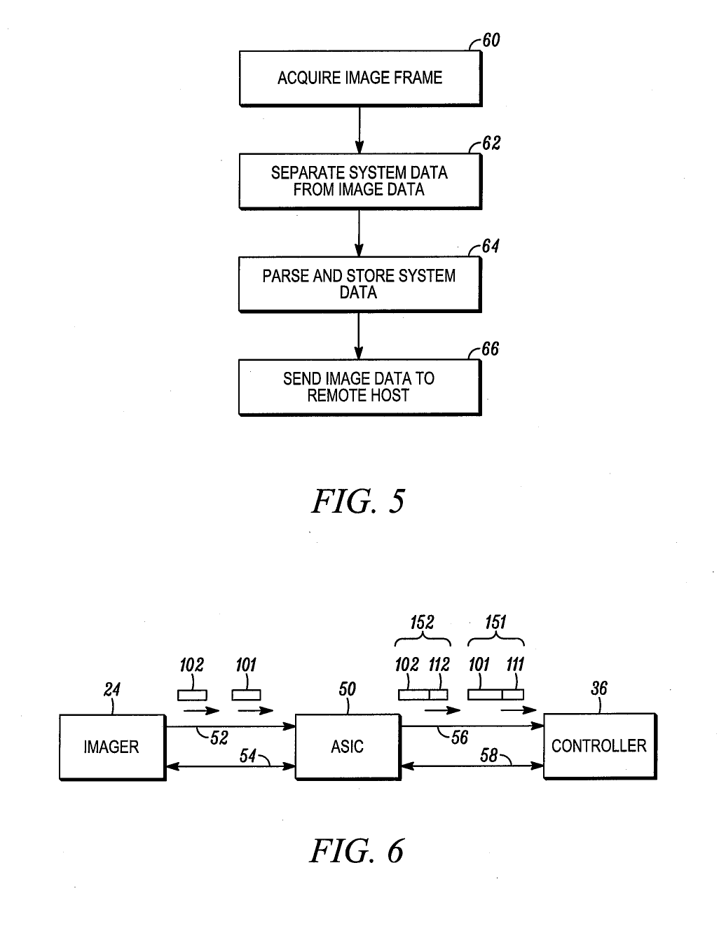

In accordance with an aspect of this invention, as shown in FIG. 3, the ASIC 50 is operatively connected to the imager 24 via an image data bus 52 over which the image data is transmitted from the imager 24 to the ASIC 50, and via a system bus 54 over which system data for controlling operation of the reader is transmitted. The system bus 54 is also sometimes referred to as the inter-integrated circuit bus, or by the acronym 12C. The ASIC 50 is operative for combining the image data and the system data to form combined data. The controller 36 is operatively connected to the ASIC 50, for receiving and processing the combined data over a combined data bus 56 from the ASIC 50, and for transmitting the processed image away from the controller 36 to the local memory 14 or a remote host. As described below in FIG. 5, the controller 36 processes the combined data by separating, and separately processing, the separated system data and the image data.

Such system data includes, among other things, control settings by which the controller 36 and/or the ASIC 50 sets one or more of the settable exposure time period for the imager 24, the settable gain for the imager 24, the settable focal length for the imaging lens assembly 20, the settable illumination time period for the illumination light, the settable intensity level for the illumination light, the settable aiming time period for the aiming light, the settable intensity level for the aiming light, as well as myriad other system functions, such as decode restrictions, de-skewing parameters, re-sampling parameters, enhancing parameters, data compression parameters, and how often and when to transmit the processed image away from the controller 36, and so on.

In the preferred embodiment, the system bus 54 between the imager 24 and the ASIC 50 is bi-directional. The ASIC 50 is operatively connected to the controller 36 via the combined data bus 56 over which the combined data is transmitted from the ASIC 50 to the controller 36, and via another system bus 58 over which the system data for controlling operation of the reader is transmitted between the ASIC 50 and the controller 36. The other system bus 58 between the ASIC 50 and the controller 36 is also bi-directional.

In the case of a two-dimensional imager 24 having multiple rows and columns, the output image data is typically sequentially transmitted in a frame, either row-by-row or column-by-column. The FRAME_VALID waveform in FIG. 4 depicts a signal waveform of a frame. An image transfer from the ASIC 50 to the controller 36 is initiated when the FRAME_VALID waveform transitions from a low to a high state. The LINE_VALID waveform in FIG. 4 depicts a signal waveform of a row or a column in the frame. The COMBINED DATA waveform in FIG. 4 depicts a signal waveform of the combined data for one of the rows or columns in the frame.

In one mode of operation, the ASIC 50 forms the combined data by appending the system data to the image data. The system data could, for example, be appended, as shown in FIG. 4, to the image data as the last row, or the last column, or some other part, of a frame. In another mode of operation, the ASIC 50 forms the combined data by overwriting the system data on part of the image data. The system data could, for example, be written over the last row, or the last column, or some other part, of a frame. Another possibility is to add short additional frames containing only the system data.

For example, a megapixel imager 24 typically has 1024 rows with 1280 pixels or columns per row. Each pixel typically has 8-10 bits of information. Assuming 8 bits per pixel, appending an additional row of system data to the image data can transfer 1280 bytes of system data, which is now associated or combined with the image data in the current frame.

As shown in the flow chart of FIG. 5, after the image is acquired in step 60, the controller 36 separates the system data from the image data in step 62, parses and stores the system data in step 64, and processes, decodes and sends the image data away from the controller 36 to, for example, a remote host in step 66.

Hence, the system data associated with the image data is kept in synchronism with the captured image, because the combined data arrives over a single bus in a single frame. There is no separate delivery of the image data over one bus and the system data over another bus from the imager 24 to the controller 36. There is no extra burden on the controller 36 as in the prior art, thereby enhancing the responsiveness and reading performance of such imaging readers.

In another embodiment as shown in FIG. 6, the ASIC 50 can be used to modify the raw data stream received from the imager 24 to generate a new stream of data that can be more easily coupled to and processed by the controller 36. As shown in FIG. 6, the raw data stream that is sent from the imager 24 to the ASIC 50 includes an image frame 101, an image frame 102, and many other image frames (not shown in the figure) following the image frames 101 and 102. The ASIC 50 can be configured to generate a stream of combined data frames wherein a combined data frame includes an image frame from the raw image data and a header. The stream of combined data frames is then sent from the ASIC 50 to the controller 36 for further processing. In FIG. 6, the stream of combined data frames that is sent to the controller 36 includes a combined data frame 151, a combined data frame 152, and many other a combined data frame (not shown in the figure) following the combined data frames 151 and 152. The combined data frame 151 includes the image frame 101 and a header 111, and the combined data frame 152 includes the image frame 102 and a header 112.

In some implementations, as shown in FIG. 6, the image frame (e.g., 101) in the combined data frame (e.g., 151) is appended to the header (e.g., 111) in the combined data frame. In other implementations, the header (e.g., 111) in the combined data frame (e.g., 151) can be appended to the image frame (e.g., 101) in the combined data frame. In some implementations, the header (e.g., 111) in the combined data frame (e.g., 151) can include a synchronization sequence (e.g., 0×FF, 0×00, 0×FF, 0×00) for aiding the controller to parse and extract the combined data frame from the stream of combined data frames. Generally, knowing the size of the combined data frame can also be used for aiding the controller to parse and extract the combined data frame from the stream of combined data frames.

In some implementations, the header (e.g., 111) in the combined data frame (e.g., 151) includes a length data therein for identifying a size of the image frame in the combined data frame. In other implementations, the header (e.g., 111) in the combined data frame (e.g., 151) can include a data therein that can generally be used to determine a size of the image frame in the combined data frame. For example, such data can specify the size of the image frame directly, and it may also specify the size of the image frame indirectly. If the size of the header is known, a data in the header that specifies the size of the combined data frame will also indirectly specifies the size of the image frame. In some other implementations, if there are a number of different types of image frames that are sent to the ASIC 50 and the size of the image frame is known for each type, then, a data in the header that specifies the type of each image frame will also indirectly specifies the size of each image frame.

When the ASIC 50 is configured to generate a stream of combined data frames wherein a combined data frame includes an image frame from the image data and a header, the controller 36 will be able to process more easily the variable image frames as captured by the imager 24. In one specific example, when a PXA31x Processor from Marvell (Nasdaq: MRVL) is used as the controller 36, the stream of combined data frames from the ASIC 50 can be processed by the PXA31x Processor in its JPEG image capture mode.

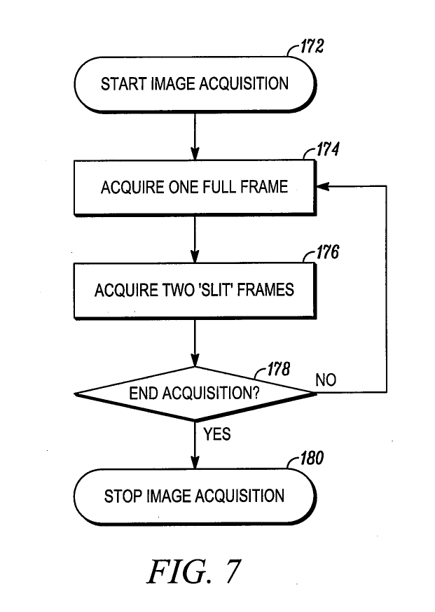

Dynamically acquiring images of different sizes has many advantages in a Barcode Imager. For example, if the barcode scanner is primarily decoding one-dimensional barcodes that are aligned with an aiming line, it is advantageous to periodically capture rectangular ‘slit’ frames that contain only a small percentage of the image rows. Capturing a sub-section of the image increases the frame rate of the image capture, thereby increasing decode aggressiveness. A flowchart of such an acquisition system is shown in FIG. 7. In FIG. 7, two out of every three frames are ‘slit’ frames boosting the 1D decode performance and one out of three frames is a full frame for 2D barcode decoding or omni-directional 1D decoding.

Another example where periodically acquiring higher speed subframes is beneficial is when performing autoexposure or autofocus. A burst of smaller frames can be analyzed to converge to the correct autoexposure or autofocus lens position faster than using slower full frames. Another example is periodically using pixel binning to increase the signal-to-noise ratio of the acquired image. When pixel binning is enabled, the sensor averages neighboring pixels and produces a lower-resolution (smaller sized) image. Another example is multiplexing two different image sensors with different resolutions (or image sizes) through the same camera port.

It will be understood that each of the elements described above, or two or more together, also may find a useful application in other types of constructions differing from the types described above. For example, the above-described use of an external ASIC can be eliminated. Instead, the above-described functionality of combining the image data and system data, as performed by the ASIC, can be integrated onto the same integrated circuit silicon chip as the imager. These advanced imaging systems are typically called system-on-a-chip (SOC) imagers.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An imaging reader for imaging targets, comprising:
a solid-state imager having an array of image sensors for capturing return light from a target over a field of view, and for generating image data corresponding to the target;
an application specific integrated circuit (ASIC) operatively connected to the solid-state imager to receive the image data from the solid-state imager, the ASIC being operative to generate a stream of combined data frames wherein a combined data frame includes an image frame from the image data and a header; and;
a controller operatively connected to the ASIC, for receiving and processing the stream of combined data frames from the ASIC.

2. The imaging reader of claim 1, wherein the header in the combined data frame includes a synchronization sequence therein for aiding the controller to parse and extract the combined data frame from the stream of combined data frames.

3. The imaging reader of claim 1, wherein the header in the combined data frame includes a length data therein for identifying a size of the image frame in the combined data frame.

4. The imaging reader of claim 1, wherein the header in the combined data frame includes a data therein applicable for determining a size of the image frame in the combined data frame.

5. The imaging reader of claim 1, wherein the image frame in the combined data frame is appended to the header in the combined data frame.

6. The imaging reader of claim 1, wherein the header in the combined data frame is appended to the image frame in the combined data frame.

7. A method of imaging targets with an imaging reader, comprising :
capturing return light from a target over a field of view of a solid-state imager having an array of image sensors, and generating image data corresponding to the target;
operatively connecting an application specific integrated circuit (ASIC) to the solid-state imager to receive the image data from the solid-state imager;
generating a stream of combined data frames by the ASIC, a combined data frame in the stream generated by the ASIC including an image frame from the image data and a header; and
receiving and processing the stream of combined data frames from the ASIC at a controller operatively connected to the ASIC.

8. The method of claim 7, wherein the header in the combined data frame includes a synchronization sequence therein for aiding the controller to parse and extract the combined data frame from the stream of combined data frames.

9. The method of claim 7, wherein the header in the combined data frame includes a length data therein for identifying a size of the image frame in the combined data frame.

10. The method of claim 7, wherein the header in the combined data frame includes a data therein applicable for determining a size of the image frame in the combined data frame.

11. The method of claim 7, wherein the image frame in the combined data frame is appended to the header in the combined data frame.

12. The method of claim 7, wherein the header in the combined data frame is appended to the image frame in the combined data frame.

13. A method of imaging targets with an imaging reader, the imaging reader including (1) a solid-state imager having an array of image sensors for capturing return light from a target over a field of view, and (2) an application specific integrated circuit (ASIC) operatively connected to the solid-state imager via an image data bus, the method comprising:
acquiring a first image frame having a first number of pixels by the solid-state imager, and combining the first image frame with a first header by the ASIC to form a first combined data frame;
acquiring a second image frame having a second number of pixels by the solid-state imager, and combining the second image frame with a second header by the ASIC to form a second combined data frame, wherein the first number of pixels for the first image frame is different from the second number of pixels for the second image frame; and
outputting from the ASIC to a controller a stream of combined data frames that includes the first combined data frame and the second combined data frame.

14. The method of claim 13, wherein a step for the outputting comprises:
appending the second combined data frame to the first combined data frame.

15. The method of claim 13, wherein a step for the outputting comprises:
appending the first combined data frame to the second combined data frame.

16. The method of claim 13, wherein the first image frame is a full frame and the second image frame is a slit frame.

17. The method of claim 13, further comprising:
acquiring a third image frame having a third number of pixels by the solid-state imager, and combining the third image frame with a third header by the ASIC to form a third combined data frame; and
wherein the first image frame is a full frame, and both the second image frame and the third image frame are slit frames.

18. The method of claim 13, wherein the first header in the first combined data frame includes a first data therein applicable for determining a size of the first image frame in the first combined data frame, and the second header in the second combined data frame includes a second data therein applicable for determining a size of the second image frame in the second combined data frame.
